(19) United States
(12) Patent Application Publication
(10) Pub. No.: US 2003/0014182 A1
(43) Pub. Date: Jan. 16, 2003

(54) Interferometric speed prediction

(76) Inventor: Michael Falco, Jupiter, FL (US)

Correspondence Address: MICHAEL FALCO, 1001 SEAFARER CIRCLE, APT 305, JUPITER, FL, 33477, US

(21) Appl. No.: 09/682,021

(22) Filed: Jul. 10, 2001

(51) Int. Cl. G06G 7/76

(52) U.S. Cl. 701/119

(57) ABSTRACT

A system for sensing speed of other vehicles without the use of radar or laser is presented. It uses interferometric techniques to passively compute another vehicle's speed. It would be useful for law enforcement officials to detect speed violators without speed violators radar or laser detectors providing any warning. The system uses two moving vehicles each equipped with a GPS receiver, data radio, tachometer, user input device and onboard laptop computer. Each window on the vehicle would be taped with two cross-hairs define the acceptable zone where the lead vehicle can start (and trail vehicle may end) the clocking procedure.

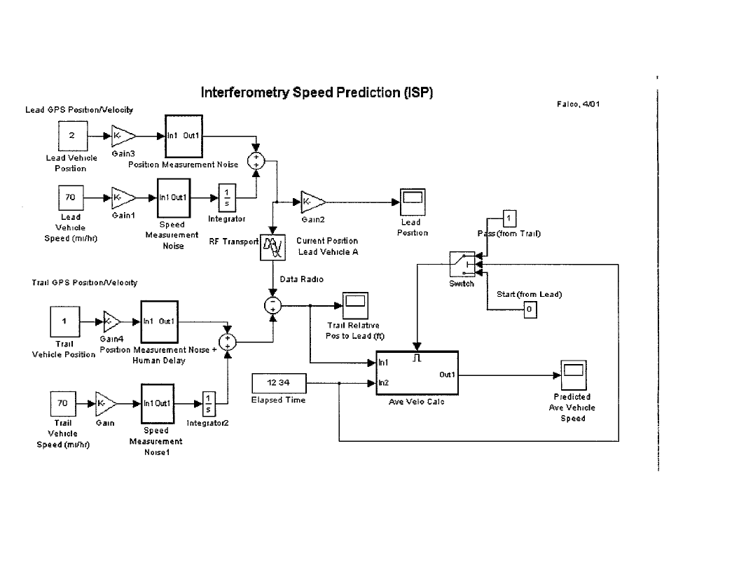

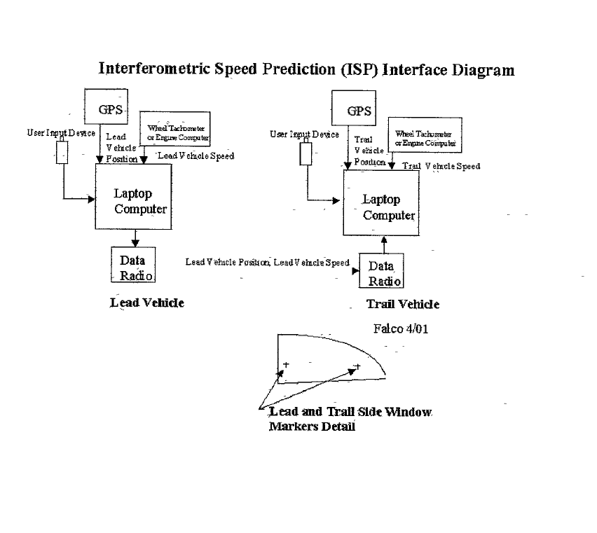

### DETAILED DESCRIPTION

A system for detecting speed of vehicles without the use of radar or laser is presented.

The Interferometric Speed Prediction uses two vehicles, a lead vehicle and a trail vehicle, each equipped with GPS receiver, data radio, tachometer, user input device and onboard laptop computer. The computer contains the ISP algorithm which receives GPS position and time, and velocity from a wheel tachometer or engine computer. When the lead vehicle user visually sees another vehicle to which they want to determine the velocity of, the user will activate the user input device to begin “clocking” the vehicle. The lead vehicle sends updates of it's position and velocity to the trail vehicle via data radio. The trail vehicle onboard laptop computer ISP algorithm continuously computers the lead vehicle and trail vehicle position and speed. When the trail vehicle user visually sees target vehicle to which they want to determine the velocity of, the user will activate the user input device to end “clocking” the vehicle. The ISP algorithm then computes the target vehicle speed in a report with date, time, and user manual data entry for other information such as vehicle type, License Number, VIN number, etc.

1. The Interferometric speed prediction uses two vehicles, a lead vehicle and a trail vehicle, each equipped with GPS receiver, data radio, tachometer, user input device and onboard laptop computer.

2. The computer contains the ISP algorithm which receives GPS position and time, and velocity from a wheel tachometer or engine computer.

3. When the lead vehicle user visually sees another vehicle to which they want to determine the velocity of, the user will activate the user input device to begin “clocking” the vehicle.

4. The lead vehicle sends updates of it's position and velocity to the trail vehicle via data radio.

5. The trail vehicle onboard laptop computer ISP algorithm continuously computers the lead vehicle and trail vehicle position and speed.

6. When the trail vehicle user visually sees target vehicle to which they want to determine the velocity of, the user will activate the user input device to end “clocking” the vehicle.

7. The ISP algorithm then computes the target vehicle speed in a report with date, time, and user ma input other information such as vehicle type, License Number, VIN number.

8. Each window on the vehicle would be taped with two cross-hairs defining the acceptable zone where the lead vehicle can start (and trail vehicle may end) the clocking procedure.
